(19) United States
(12) Patent Application Publication
(10) Pub. No.: US 2010/0150248 A1
(43) Pub. Date: Jun. 17, 2010

(54) METHOD AND APPARATUS FOR ERROR CONCEALMENT IN MULTI-VIEW CODED VIDEO

(75) Inventors: Purvin Bibhas Pandit, Franklin Park, NJ (US); Peng Yin, West Windsor, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing, Princeton, NJ (US)

(21) Appl. No.: 12/733,103

(22) PCT Filed: Aug. 11, 2008
(86) PCT No.: PCT/US2008/009573

§ 371 Date: Feb. 9, 2010

Related U.S. Application Data
(60) Provisional application No. 60/955,899, filed on Aug. 15, 2007.

(51) Int. Cl. H04N 7/26

(52) U.S. Cl. 375/240.25; 375/E07.027

(57) ABSTRACT

There are provided a method and apparatus for error concealment in multi-view coded video. The apparatus includes a decoder (200) for decoding multi-view video content using error concealment based on at least one of inter-view picture information and inter-view dependency information.

### CROSS-REFERENCE TO RELATED APPLICATIONS

This application claims the benefit of U.S. Provisional Application Ser. No. 60/955,899, filed 15 Aug. 2007, which is incorporated by reference herein in its entirety.

### TECHNICAL FIELD

The present principles relate generally to video decoding and, more particularly, to methods and apparatus for error concealment in multi-view coded video.

### BACKGROUND

A multi-view video coding scheme is a video coding system with pictures from several different cameras combined to obtain either a high coding efficiency or to support certain applications like three-dimensional (3D) television, free view point television, and so forth. Robust transmission of many views is not always guaranteed and, thus, provisions need to be made for concealing lost or damaged pictures as performed in traditional single view coding.

There exist several prior art error concealment approaches that address single-view coding. Roughly, we can classify those techniques as spatial error correction (EC), temporal error correction, or joint spatio-temporal error correction.

### SUMMARY

These and other drawbacks and disadvantages of the prior art are addressed by the present principles, which are directed to methods and apparatus for error concealment in multi-view coded video.

According to an aspect of the present principles, there is provided an apparatus. The apparatus includes a decoder for decoding multi-view video content using error concealment based on at least one of inter-view picture information and inter-view dependency information.

According to another aspect of the present principles, there is provided a method. The method includes decoding multi-view video content using error concealment based on at least one of inter-view picture information and inter-view dependency information.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary Multi-view Video Coding (MVC) encoder to which the present principles may be applied, in accordance with an embodiment of the present principles;

FIG. 2 is a block diagram for an exemplary Multi-view Video Coding (MVC) decoder to which the present principles may be applied, in accordance with an embodiment of the present principles;

FIG. 3 is a diagram for a time-first coding structure for a multi-view video coding system with 8 views to which the present principles may be applied, in accordance with an embodiment of the present principles;

FIG. 4 is a flow diagram for an exemplary method for error concealment in multi-view video coding, in accordance with an embodiment of the present principles;

FIG. 5 is a flow diagram for another exemplary method for error concealment in multi-view video coding, in accordance with an embodiment of the present principles;

FIG. 6 is a flow diagram for another exemplary method for error concealment in multi-view video coding, in accordance with an embodiment of the present principles;

FIG. 7 is a flow diagram for another exemplary method for error concealment in multi-view video coding, in accordance with an embodiment of the present principles;

FIG. 8 is a flow diagram for another exemplary method for error concealment in multi-view video coding, in accordance with an embodiment of the present principles;

FIG. 9 is a flow diagram for another exemplary method for error concealment in multi-view video coding, in accordance with an embodiment of the present principles; and

FIG. 10 is a flow diagram for another exemplary method for error concealment in multi-view video coding, in accordance with an embodiment of the present principles.

### DETAILED DESCRIPTION

The present principles are directed to methods and apparatus for error concealment in multi-view coded video.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment. Moreover, while certain embodiments herein are referred to by a number (e.g., embodiment 1, embodiment 2, and so forth), such embodiments may be implemented alone or in any combination, as is readily apparent to one of ordinary skill in this and related arts, while maintaining the spirit of the present principles.

As used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, Picture Parameter Set (PPS) level, Sequence Parameter Set (SPS) level, View Parameter Set (VPS) level, and Network Abstraction Layer (NAL) unit header level.

Moreover, as interchangeably used herein, “cross-view” and “inter-view” both refer to pictures that belong to a view other than a current view.

Further, as used herein, “plurality” refers to two or more of an item. Thus, for example, a “plurality of regional disparity vectors” refers to two or more regional disparity vectors.

Also, as used herein, the term “error” with respect to a picture currently being decoded refers to any of an error (e.g., damage) in the current picture or a loss of the current picture (e.g., not received), and so forth.

It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, it is to be appreciated that while one or more embodiments of the present principles are described herein with respect to the multi-view video coding (MVC) extension of the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), the present principles are not limited to solely this standard and, thus, may be utilized with respect to other video coding standards, recommendations, and extensions thereof relating to multi-view video coding, including extensions of the MPEG-4 AVC standard, while maintaining the spirit of the present principles.

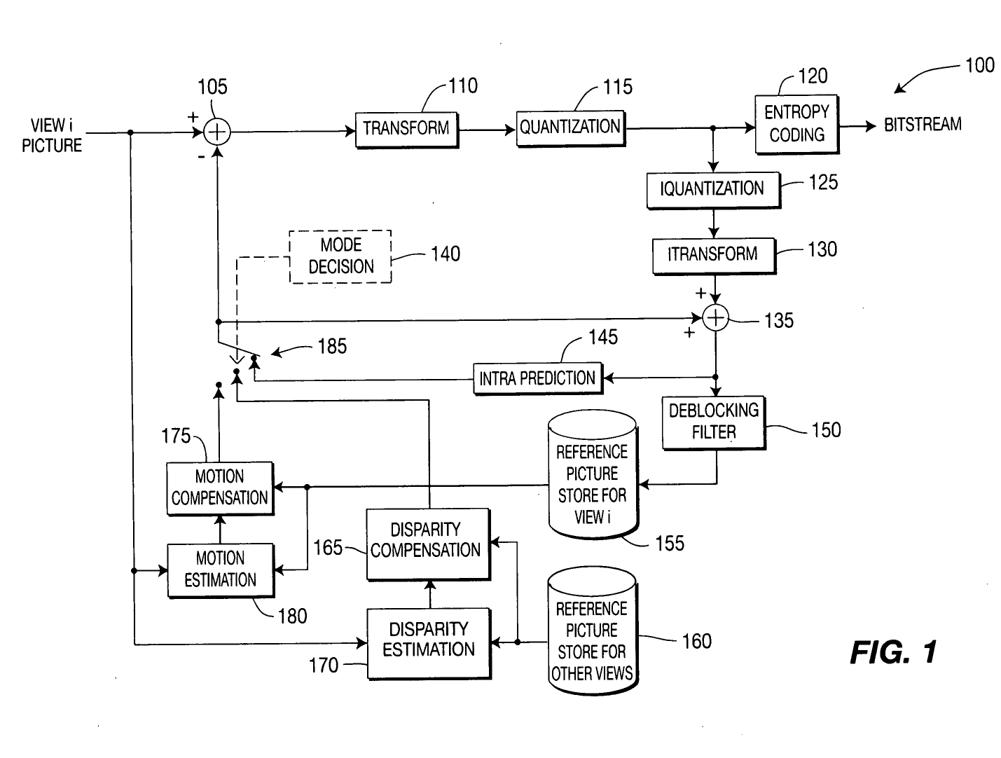

Turning to FIG. 1, an exemplary Multi-view Video Coding (MVC) encoder is indicated generally by the reference numeral 100. The encoder 100 includes a combiner 105 having an output connected in signal communication with an input of a transformer 110. An output of the transformer 110 is connected in signal communication with an input of quantizer 115. An output of the quantizer 115 is connected in signal communication with an input of an entropy coder 120 and an input of an inverse quantizer 125. An output of the inverse quantizer 125 is connected in signal communication with an input of an inverse transformer 130. An output of the inverse transformer 130 is connected in signal communication with a first non-inverting input of a combiner 135. An output of the combiner 135 is connected in signal communication with an input of an intra predictor 145 and an input of a deblocking filter 150. An output of the deblocking filter 150 is connected in signal communication with an input of a reference picture store 155 (for view i). An output of the reference picture store 155 is connected in signal communication with a first input of a motion compensator 175 and a first input of a motion estimator 180. An output of the motion estimator 180 is connected in signal communication with a second input of the motion compensator 175

An output of a reference picture store 160 (for other views) is connected in signal communication with a first input of a disparity/illumination estimator 170 and a first input of a disparity/illumination compensator 165. An output of the disparity/illumination estimator 170 is connected in signal communication with a second input of the disparity/illumination compensator 165.

An output of the entropy decoder 120 is available as an output of the encoder 100. A non-inverting input of the combiner 105 is available as an input of the encoder 100, and is connected in signal communication with a second input of the disparity/illumination estimator 170, and a second input of the motion estimator 180. An output of a switch 185 is connected in signal communication with a second non-inverting input of the combiner 135 and with an inverting input of the combiner 105. The switch 185 includes a first input connected in signal communication with an output of the motion compensator 175, a second input connected in signal communication with an output of the disparity/illumination compensator 165, and a third input connected in signal communication with an output of the intra predictor 145.

A mode decision module 140 has an output connected to the switch 185 for controlling which input is selected by the switch 185.

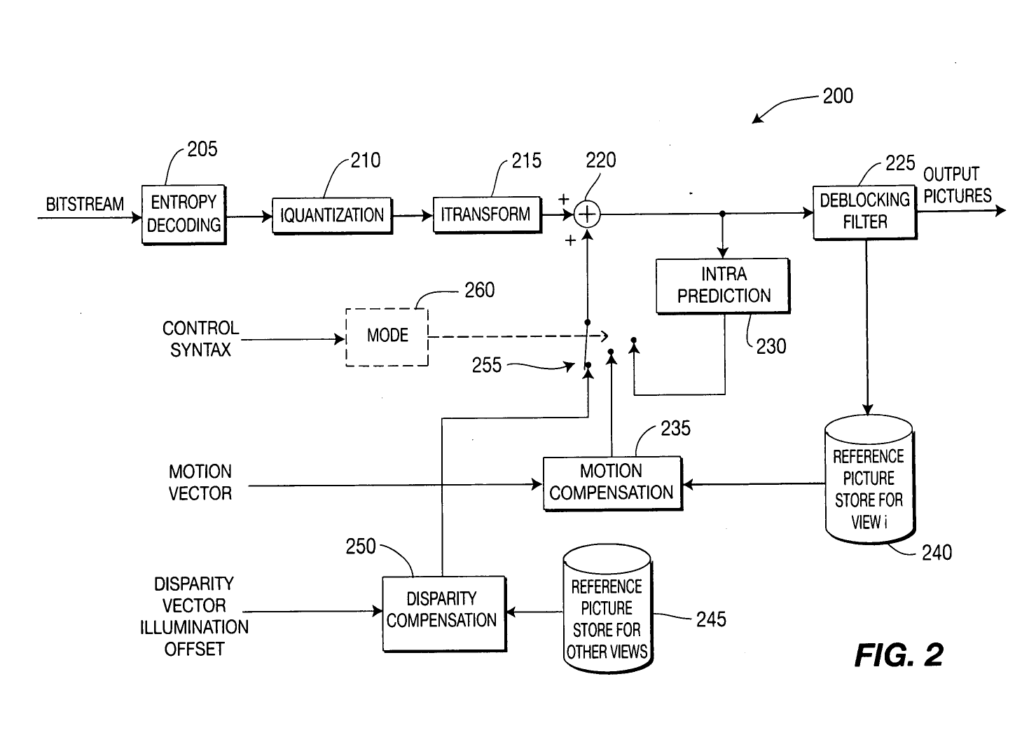

Turning to FIG. 2, an exemplary Multi-view Video Coding (MVC) decoder is indicated generally by the reference numeral 200. The decoder 200 includes an entropy decoder 205 having an output connected in signal communication with an input of an inverse quantizer 210. An output of the inverse quantizer is connected in signal communication with an input of an inverse transformer 215. An output of the inverse transformer 215 is connected in signal communication with a first non-inverting input of a combiner 220. An output of the combiner 220 is connected in signal communication with an input of a deblocking filter 225 and an input of an intra predictor 230. An output of the deblocking filter 225 is connected in signal communication with an input of a reference picture store 240 (for view i). An output of the reference picture store 240 is connected in signal communication with a first input of a motion compensator 235.

An output of a reference picture store 245 (for other views) is connected in signal communication with a first input of a disparity/illumination compensator 250.

An input of the entropy coder 205 is available as an input to the decoder 200, for receiving a residue bitstream. Moreover, an input of a mode module 260 is also available as an input to the decoder 200, for receiving control syntax to control which input is selected by the switch 255. Further, a second input of the motion compensator 235 is available as an input of the decoder 200, for receiving motion vectors. Also, a second input of the disparity/illumination compensator 250 is available as an input to the decoder 200, for receiving disparity vectors and illumination compensation syntax.

An output of a switch 255 is connected in signal communication with a second non-inverting input of the combiner 220. A first input of the switch 255 is connected in signal communication with an output of the disparity/illumination compensator 250. A second input of the switch 255 is connected in signal communication with an output of the motion compensator 235. A third input of the switch 255 is connected in signal communication with an output of the intra predictor 230. An output of the mode module 260 is connected in signal communication with the switch 255 for controlling which input is selected by the switch 255. An output of the deblocking filter 225 is available as an output of the decoder.

A Multi-view Video Coding (MVC) sequence is a set of two or more video sequences that capture the same scene from a different view point. We have recognized that multi-view coded (MVC) sequences present special problems for error concealment.

Accordingly and advantageously, the present principles are directed to methods and apparatus for error concealment in multi-view coded video. In providing such methods and apparatus, the present principles exploit the additional redundancy between the different views.

The redundancy between these different views can be exploited to enhance and improve upon the current error concealment techniques that are used for single-view coding. We will classify the proposed error correction (EC) using view information as view error correction. We propose that view error correction can be used individually, or be jointly applied with spatial and/or temporal error correction.

A multi-view coding system is currently being developed for the MPEG-4 AVC Standard. Accordingly, the following description of one or more embodiment in accordance with the present principles will be described in a context corresponding to the MPEG-4 AVC Standard although, as noted above, the present principles are not limited solely to this standard or extensions thereof.

A multi-view video coding (MVC) system includes several views looking at a scene from different positions. A multi-view video coding system uses a lot of inter-camera correlation to improve the coding efficiency of the system.

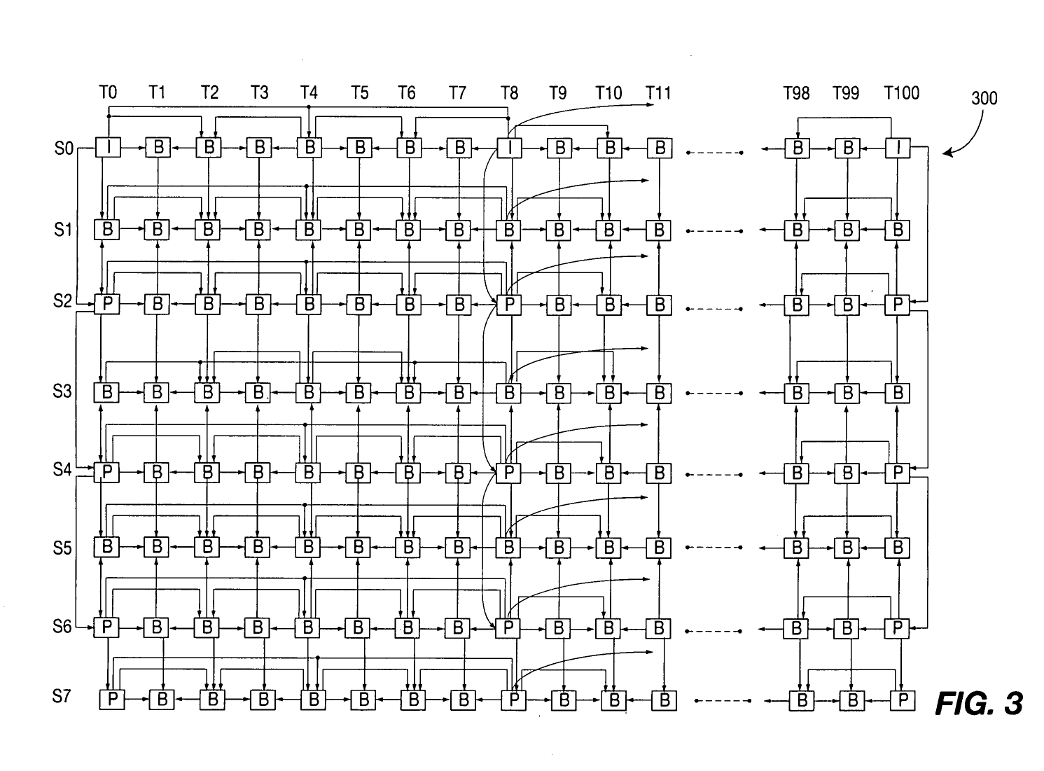

Turning to FIG. 3, a time-first coding structure for a multi-view video coding system with 8 views is indicated generally by the reference numeral 300. In the example of FIG. 3, all pictures at the same time instance from different views are coded contiguously. Thus, all pictures (S0-S7) at time instant T0 are coded first, followed by pictures (S0-S7) at time T8, and so on. This is called time-first coding.

Also, the current multi-view video coding (MVC) extension of the MPEG-4 AVC Standard includes a constraint that inter-view prediction can only be done by using pictures at that time instance. Thus, this makes it all the more relevant to detect picture loss at this time instance since the picture that is lost may be used not only as a temporal reference but also as a view reference.

As can be seen from FIG. 3, there is a lot of redundancy that is exploited in such a multi-view video coding system. We use this redundancy to improve error concealment techniques.

### Embodiment 1 (Picture Copy)

In the multi-view video coding system of the MPEG-4 AVC Standard, time-first coding is performed where all the pictures at a certain time instance are coded first.

The first step in error concealment is detection. After the detection step is performed, the lost picture is concealed in an optimal way. One of the methods that can be used is picture copy. Traditionally, in the single-view case, picture copy involved copying a picture from a previous time instance in the current location. Alternatively, taken a step further, the lost picture can be interpolated from pictures of the previous time instance and pictures of the following time instance if such pictures are available. However, this is not optimal since it causes a picture-freeze effect and also severely affects the subsequent pictures.

With multi-view video coding, we have recognized that it is possible to copy or interpolate a picture from the already decoded pictures at the same time instance from a different view. This has the advantage that the picture from another view is synchronized with the concealed picture and, thus, is potentially a better representation of the lost picture.

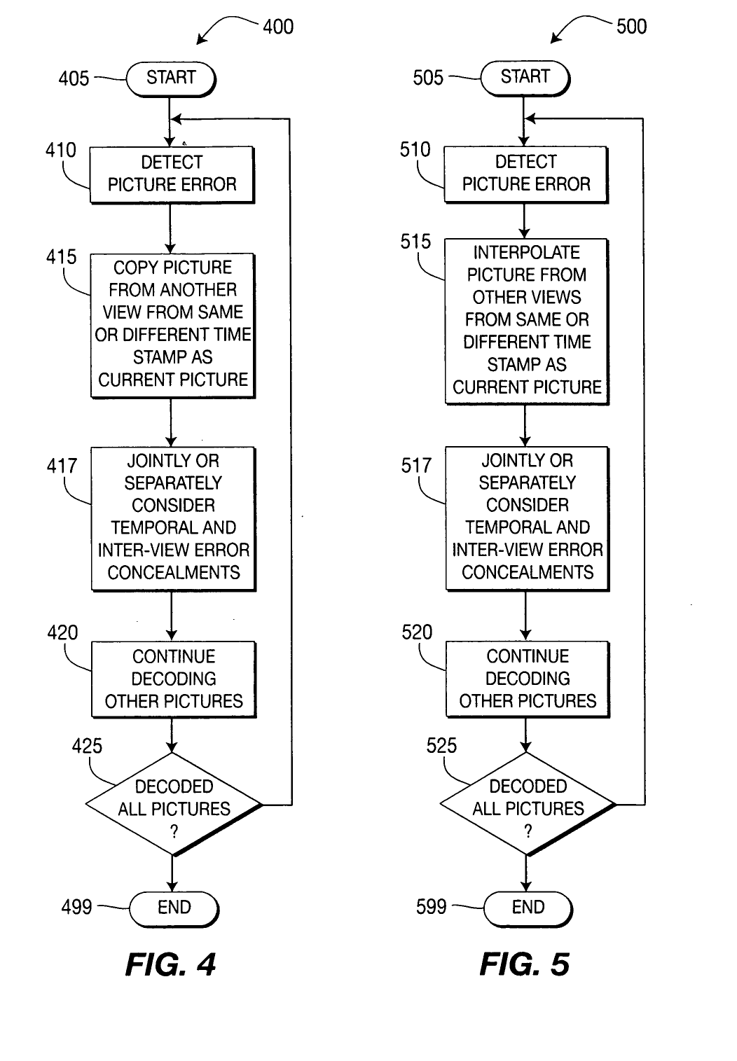

Turning to FIG. 4, an exemplary method for error concealment in multi-view video coding is indicated generally by the reference numeral 400.

The method 400 includes a start block 405 that passes control to a function block 410. The function block 410 detects a picture error with respect to a current picture being decoded for a current view, and passes control to a function block 415. The function block 415 copies the picture from another view from the same or different time stamp as the current picture to obtain a concealment picture for the current picture, and passes control to a function block 417. The function block 417 jointly or separately considers temporal and inter-view error concealments, and passes control to a function block 420. The function block 420 continues decoding other pictures, and passes control to a decision block 425. The decision block 425 decodes determines whether all pictures have been decoded. If so, the control is passed to an end block 499. Otherwise, control is returned to the function block 410.

Turning to FIG. 5, another exemplary method for error concealment in multi-view video coding is indicated generally by the reference numeral 500.

The method 500 includes a start block 505 that passes control to a function block 510. The function block 510 detects a picture error for a current picture being decoded for a current view, and passes control to a function block 515. The function block 515 interpolates one or more pictures from other views with respect to the current view, from the same or different time stamp as the current picture, to generate a concealment picture for the current picture, and passes control to a function block 517. The function block 517 jointly or separately considers temporal and inter-view error concealments, and passes control to a function block 520. The function block 520 continues decoding other pictures, and passes control to a decision block 525. The decision block 525 decodes determines whether all pictures have been decoded. If so, the control is passed to an end block 599. Otherwise, control is returned to the function block 510.

### Embodiment 2 (View Generation)

Multi-view coded video may support the transmission of camera parameters for each view and additionally the depth information for each picture of a view. View synthesis is used to generate a view using the camera parameters and depth information for view prediction or to generate virtual views for free view point television. View generation can be additionally used to conceal lost pictures. When a picture of a certain view is lost, the camera parameters transmitted using a high level syntax along with the depth information can be used to generate the view. The generated picture can be a good approximation of the lost picture.

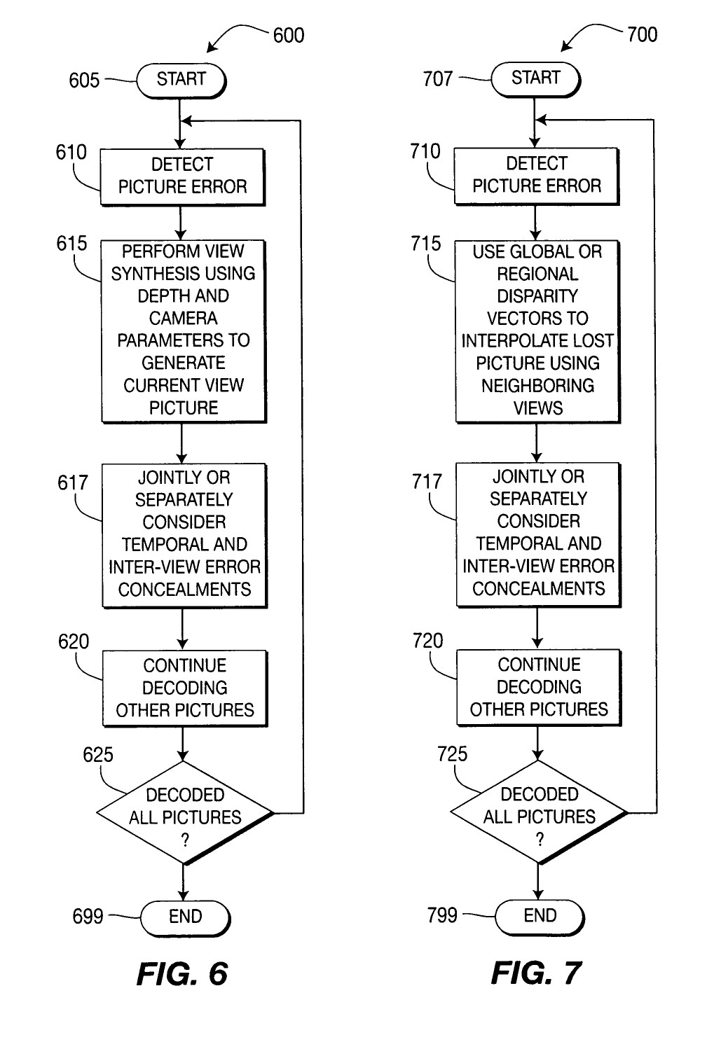

Turning to FIG. 6, another exemplary method for error concealment in multi-view video coding is indicated generally by the reference numeral 600.

The method 600 includes a start block 605 that passes control to a function block 610. The function block 610 detects a picture error for a current picture being decoded for a current view, and passes control to a function block 615. The function block 615 performs view synthesis using depth and camera parameters to generate a concealment picture for the current picture, and passes control to a function block 617. The function block 617 jointly or separately considers temporal and inter-view error concealments, and passes control to a function block 620. The function block 620 continues decoding other pictures, and passes control to a decision block 625. The decision block 625 decodes determines whether all pictures have been decoded. If so, the control is passed to an end block 699. Otherwise, control is returned to the function block 610.

### Embodiment 3 (Global/Regional Disparity Information)

Global disparity vectors (GDVs) and/or regional disparity vectors (RDVs) may be transmitted using a high level syntax in the multi-view video coding system. These global disparity vectors and regional disparity vectors respectively represent a global shift or a regional shift of the current view with respect to a reference view. For a picture that is lost, global disparity vector information and/or regional disparity vector information can be used along with picture copy to shift the picture by this vector. This will result in creating empty spaces after the shift which are filled using one or more appropriate concealment techniques.

Turning to FIG. 7, another exemplary method for error concealment in multi-view video coding is indicated generally by the reference numeral 700.

The method 700 includes a start block 705 that passes control to a function block 710. The function block 710 detects a picture error for a current picture being decoded for a current view, and passes control to a function block 715. The function block 715 uses global disparity vectors or regional disparity vectors with respect to neighboring views to generate a concealment picture for the current picture, and passes control to a function block 717. The function block 717 jointly or separately considers temporal and inter-view error concealments, and passes control to a function block 720. The function block 720 continues decoding other pictures, and passes control to a decision block 725. The decision block 725 decodes determines whether all pictures have been decoded. If so, the control is passed to an end block 799. Otherwise, control is returned to the function block 710.

### Embodiment 4 (Motion and/or Residual Copy)

Motion skip was proposed as a coding tool in one prior art approach. According to that prior art approach, motion and mode information are copied from another view (based on the dependency indicated in the Sequence Parameter Set) for certain macroblocks (as indicated in the bitstream) and uses this information to do motion compensation on the temporal pictures. This concept can be extended to residual prediction where the residual information from another view is inherited for the current view for coding efficiency.

These techniques can be used for error concealment in case a picture is lost. When a picture is lost we can treat all the macroblocks as motion skip macroblocks and inherit the motion, mode and potentially the residual information from a picture of a neighboring view. Once the motion, mode and residual information is copied, we have all the information needed to decode the current picture using temporal pictures as references.

An extension of this method is to also copy all the memory management control operations (MMCO) and Reference Picture List Reordering (RPLR) commands associated with the neighboring view to the current picture being concealed.

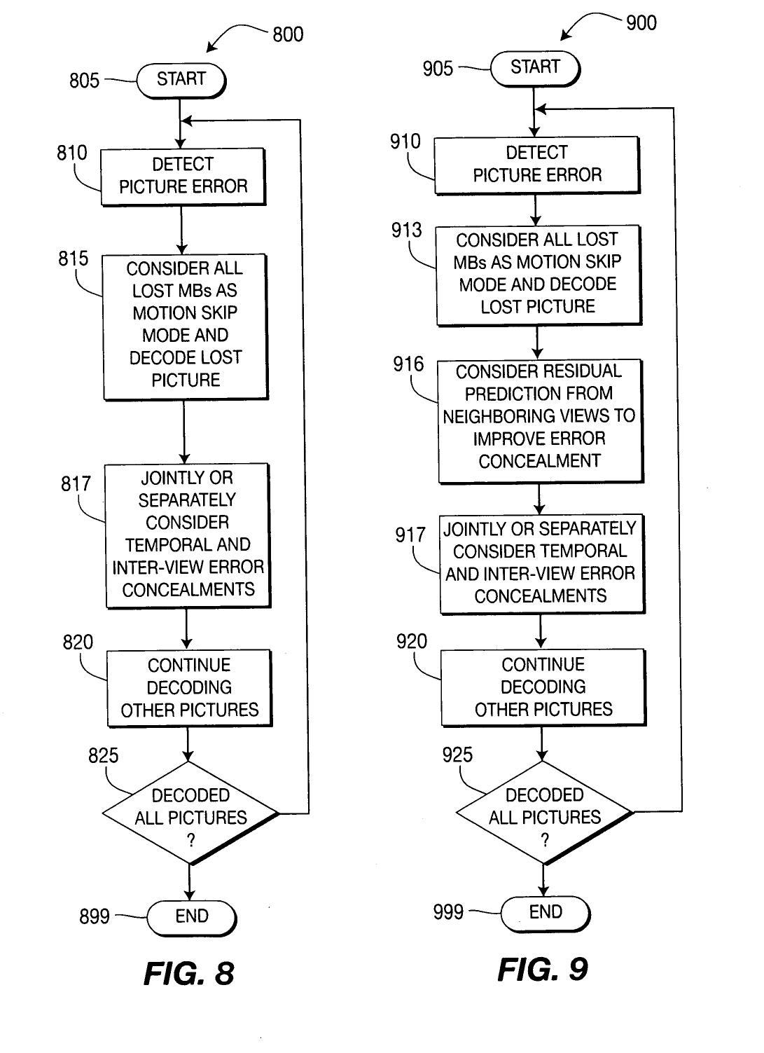

Turning to FIG. 8, another exemplary method for error concealment in multi-view video coding is indicated generally by the reference numeral 800. The method 800 includes a start block 805 that passes control to a function block 810. The function block 810 detects a picture error for a current picture being decoded for a current view, and passes control to a function block 815. The function block 815 decodes the current picture by considering all macroblocks of the current picture as motion skip mode macroblocks to generate a concealment picture for the current picture, and passes control to a function block 817. The function block 817 jointly or separately considers temporal and inter-view error concealments, and passes control to a function block 820. The function block 820 continues decoding other pictures, and passes control to a decision block 825. The decision block 825 decodes determines whether all pictures have been decoded. If so, the control is passed to an end block 899. Otherwise, control is returned to the function block 810.

Turning to FIG. 9, another exemplary method for error concealment in multi-view video coding is indicated generally by the reference numeral 900.

The method 900 includes a start block 905 that passes control to a function block 910. The function block 910 detects a picture error for a current picture being decoded for a current view, and passes control to a function block 913. The function block 913 decodes the current picture by considering all macroblocks (MBs) of the current picture as motion skip mode macroblocks to generate a concealment picture for the current picture, and passes control to a function block 916. The function block 916 considers a residual prediction from one or more neighboring views to improve the concealment picture and, hence, the error concealment, and passes control to a function block 917. The function block 917 jointly or separately considers temporal and inter-view error concealments, and passes control to a function block 920. The function block 920 continues decoding other pictures, and passes control to a decision block 925. The decision block 925 decodes determines whether all pictures have been decoded. If so, the control is passed to an end block 999. Otherwise, control is returned to the function block 910.

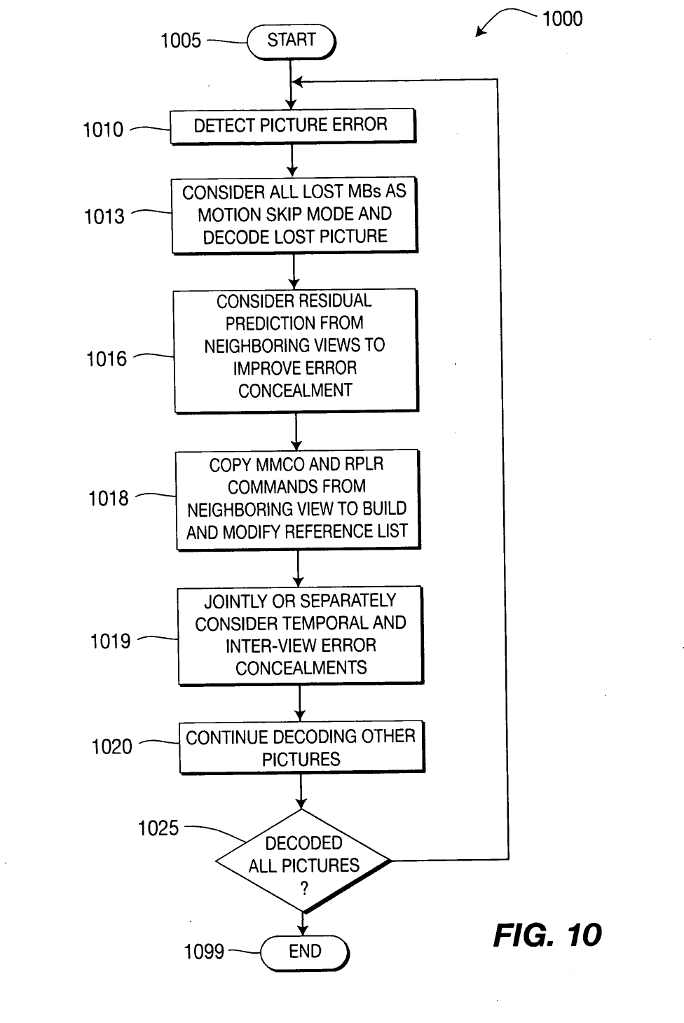

Turning to FIG. 10, another exemplary method for error concealment in multi-view video coding is indicated generally by the reference numeral 900.

The method 1000 includes a start block 1005 that passes control to a function block 1010. The function block 1010 detects a picture error for a current picture being decoded for a current view, and passes control to a function block 1013. The function block 1013 decodes the current picture by considering all macroblocks (MBs) of the current picture as motion skip mode macroblocks to generate a concealment picture for the current picture, and passes control to a function block 1016. The function block 1016 considers a residual prediction from one or more neighboring views to improve the concealment picture and, hence, the error concealment, and passes control to a function block 1018. The function block 1018 copies memory management control operations commands and RPLR commands from one or more neighboring views to build and modify a reference list for the current picture (that is to be represented by the concealment picture), and passes control to a function block 1019. The function block 1019 jointly or separately considers temporal and inter-view error concealments, and passes control to a function block 1020. The function block 1020 continues decoding other pictures, and passes control to a decision block 1025. The decision block 1025 decodes determines whether all pictures have been decoded. If so, the control is passed to an end block 1099. Otherwise, control is returned to the function block 1010.

A description will now be given of some of the many attendant advantages/features of the present invention, some of which have been mentioned above. For example, one advantage/feature is an apparatus that includes a decoder for decoding multi-view video content using error concealment based on at least one of inter-view picture information and inter-view dependency information.

Another advantage/feature is the apparatus having the decoder as described above, wherein for a current picture being decoded for a current view and detected as having an error, the error concealment includes copying a picture from another view as a concealment picture for the current picture.

Yet another advantage/feature is the apparatus having the decoder wherein the error concealment includes copying a picture from another view as a concealment picture for the current picture as described above, wherein the picture from the other view belongs to one of a same time instant as the current picture or a different time instant than the current picture.

Still another advantage/feature is the apparatus having the decoder as described above, wherein for a current picture being decoded for a current view and detected as having an error, the error concealment includes interpolating pictures from other views to obtain a concealment picture for the current picture.

Moreover, another advantage/feature is the apparatus having the decoder wherein the error concealment includes interpolating pictures from other views to obtain a concealment picture for the current picture as described above, wherein the pictures from the other views belong to one of a same time instant as the current picture or a different time instant than the current picture.

Further, another advantage/feature is the apparatus having the decoder as described above, wherein for a current picture being decoded for a current view and detected as having an error, the error concealment includes using view synthesis to obtain a concealment picture for the current picture.

Also, another advantage/feature is the apparatus having the decoder wherein the error concealment includes using view synthesis to obtain a concealment picture for the current picture as described above, wherein the view synthesis produces a synthesized picture used as the concealment picture.

Additionally, another advantage/feature is the apparatus having the decoder wherein the error concealment includes using view synthesis to obtain a concealment picture for the current picture as described above, wherein the view synthesis produces a synthesized picture that is further refined, such that the refined synthesized picture is used as the concealment picture.

Moreover, another advantage/feature is the apparatus having the decoder wherein the error concealment includes using view synthesis to obtain a concealment picture for the current picture as described above, wherein the view synthesis uses depth information and camera parameters to produce a synthesized picture used as the concealment picture

Further, another advantage/feature is the apparatus having the decoder as described above, wherein for a current picture being decoded for a current view and detected as having an error, the error concealment includes at least one of predicting and interpolating a concealment picture for the current picture using at least one of global disparity vectors and regional disparity vectors.

Also, another advantage/feature is the apparatus having the decoder as described above, wherein for a current picture being decoded for a current view and detected as having an error, the error concealment includes decoding all macroblocks of the current picture using motion skip mode.

Additionally, another advantage/feature is the apparatus having the decoder as described above, wherein for a current picture being decoded for a current view and detected as having an error, the decoder refines the error concealment of the current picture using a residual prediction from another view.

Moreover, another advantage/feature is the apparatus having the decoder as described above, wherein for a current picture being decoded for a current view and detected as having an error, the decoder copies memory management control operations commands and reference picture list reordering commands from another view to build and modify a reference list for the current picture.

Further, another advantage/feature is the apparatus having the decoder as described above, wherein for a current picture being decoded for a current view and detected as having an error, the decoder uses view error concealment individually or jointly with at least one of spatial error concealment and temporal error concealment.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a decoder for decoding multi-view video content using error concealment based on at least one of inter-view picture information and inter-view dependency information.

2. The apparatus of claim 1, wherein for a current picture being decoded for a current view and detected as having an error, the error concealment comprises copying a picture from another view as a concealment picture for the current picture.

3. The apparatus of claim 2, wherein the picture from the other view belongs to one of a same time instant as the current picture or a different time instant than the current picture.

4. The apparatus of claim 1, wherein for a current picture being decoded for a current view and detected as having an error, the error concealment comprises interpolating pictures from other views to obtain a concealment picture for the current picture.

5. The apparatus of claim 1, wherein for a current picture being decoded for a current view and detected as having an error, the error concealment comprises using view synthesis to obtain a concealment picture for the current picture.

6. The apparatus of claim 5, wherein the view synthesis produces a synthesized picture used as the concealment picture.

7. The apparatus of claim 5, wherein the view synthesis uses depth information and camera parameters to produce a synthesized picture used as the concealment picture

8. The apparatus of claim 1, wherein for a current picture being decoded for a current view and detected as having an error, the error concealment comprises at least one of predicting and interpolating a concealment picture for the current picture using at least one of global disparity vectors and regional disparity vectors.

9. The apparatus of claim 1, wherein for a current picture being decoded for a current view and detected as having an error, the error concealment comprises decoding all macroblocks of the current picture using motion skip mode.

10. The apparatus of claim 1, wherein for a current picture being decoded for a current view and detected as having an error, said decoder refines the error concealment of the current picture using a residual prediction from another view.

11. The apparatus of claim 1, wherein for a current picture being decoded for a current view and detected as having an error, said decoder copies memory management control operations commands and reference picture list reordering commands from another view to build and modify a reference list for the current picture.

12. The apparatus of claim 1, wherein for a current picture being decoded for a current view and detected as having an error, said decoder (200) uses view error concealment individually or jointly with art least one of spatial error concealment and temporal error concealment.

13. A method, comprising:
decoding multi-view video content using error concealment based on at least one of inter-view picture information and inter-view dependency information.

14. The method of claim 13, wherein for a current picture being decoded for a current view and detected as having an error, the error concealment comprises copying a picture from another view as a concealment picture for the current picture.

15. The method of claim 13, wherein for a current picture being decoded for a current view and detected as having an error, the error concealment comprises interpolating pictures from other views to obtain a concealment picture for the current picture.

16. The method of claim 13, wherein for a current picture being decoded for a current view and detected as having an error, the error concealment comprises using view synthesis to obtain a concealment picture for the current picture.

17. The method of claim 16, wherein the view synthesis produces a synthesized picture used as the concealment picture.

18. The method of claim 16, wherein the view synthesis produces a synthesized picture that is further refined, such that the refined synthesized picture is used as the concealment picture.

19. The method of claim 16, wherein the view synthesis uses depth information and camera parameters to produce a synthesized picture used as the concealment picture.

20. The method of claim 13, wherein for a current picture being decoded for a current view and detected as having an error, the error concealment comprises at least one of predicting and interpolating a concealment picture for the current picture using at least one of global disparity vectors and regional disparity vectors.

21. The method of claim 13, wherein for a current picture being decoded for a current view and detected as having an error, the error concealment comprises decoding all macroblocks of the current picture using motion skip mode.

22. The method of claim 13, wherein for a current picture being decoded for a current view and detected as having an error, said decoding step refines the error concealment of the current picture using a residual prediction from another view.

23. The method of claim 13, wherein for a current picture being decoded for a current view and detected as having an error, said decoding step comprises copying memory management control operations commands and reference picture list reordering commands from another view to build and modify a reference list for the current picture.
